(19) United States
(12) Patent Application Publication
(10) Pub. No.: US 2021/0360534 A1
(43) Pub. Date: Nov. 18, 2021

(54) INTEGRATED ACCESS AND BACKHAUL (IAB) DOWNLINK POWER CONTROL

(71) Applicant: INTEL CORPORATION, SANTA CLARA, CA (US)

(72) Inventors: Lili Wei, Portland, OR (US); Qian Li, Beaverton, OR (US); Geng Wu, Portland, OR (US)

(21) Appl. No.: 17/390,540

(22) Filed: Jul. 30, 2021

Related U.S. Application Data
(60) Provisional application No. 63/061,702, filed on Aug. 5, 2020.

(51) Int. Cl. H04W 52/14; H04W 52/24; H04W 52/10; H04W 52/36; H04W 88/14

(52) U.S. Cl. CPC H04W 52/143; H04W 52/242; H04W 88/14; H04W 52/367; H04W 52/10

(57) ABSTRACT

To configure an IAB node for DL power control, the processing circuitry of the node is to decode at a DU function of the IAB node, an UL reference signal received via a communication channel from an MT function of a second IAB node. A path loss associated with the communication channel is determined, based on at least one measurement of the UL reference signal. DL transmission power is determined using the path loss. Data is encoded for a transmission to the MT function of the second IAB node using the DL transmission power, the transmission further using a DL BWP associated with the channel.

### PRIORITY CLAIM

This application claims the benefit of priority to U.S. Provisional Patent Application Ser. No. 63/061,702, filed Aug. 5, 2020, and entitled “MECHANISMS FOR IAB BACKHAUL DOWNLINK POWER CONTROL,” which application is incorporated herein by reference in its entirety.

### TECHNICAL FIELD

Aspects pertain to wireless communications. Some aspects relate to wireless networks including 3GPP (Third Generation Partnership Project) networks, 3GPP LTE (Long Term Evolution) networks, 3GPP LTE-A (LTE Advanced) networks, and fifth-generation (5G) networks including 5G new radio (NR) (or 5G-NR) networks and 5G-LTE networks. Other aspects are directed to systems and methods for configuring integrated access and backhaul (IAB) downlink (DL) power control.

### BACKGROUND

Mobile communications have evolved significantly from early voice systems to today's highly sophisticated integrated communication platform. With the increase in different types of devices communicating with various network devices, usage of 3GPP LTE systems has increased. The penetration of mobile devices (user equipment or UEs) in modern society has continued to drive demand for a wide variety of networked devices in a number of disparate environments. Fifth-generation (5G) wireless systems are forthcoming and are expected to enable even greater speed, connectivity, and usability. Next generation 5G networks (or NR networks) are expected to increase throughput, coverage, and robustness and reduce latency and operational and capital expenditures. 5G-NR networks will continue to evolve based on 3GPP LTE-Advanced with additional potential new radio access technologies (RATs) to enrich people's lives with seamless wireless connectivity solutions delivering fast, rich content and services. As current cellular network frequency is saturated, higher frequencies, such as millimeter wave (mmWave) frequency, can be beneficial due to their high bandwidth.

Potential LTE operation in the unlicensed spectrum includes (and is not limited to) the LTE operation in the unlicensed spectrum via dual connectivity (DC), or DC-based LAA, and the standalone LTE system in the unlicensed spectrum, according to which LTE-based technology solely operates in the unlicensed spectrum without requiring an “anchor” in the licensed spectrum, called MulteFire. MulteFire combines the performance benefits of LTE technology with the simplicity of Wi-Fi-like deployments.

Further enhanced operation of LTE systems in the licensed, as well as unlicensed spectrum, is expected in future releases and 5G systems. Such enhanced operations can include techniques for configuring IAB DL power control.

### BRIEF DESCRIPTION OF THE FIGURES

In the figures, which are not necessarily drawn to scale, like numerals may describe similar components in different views. Like numerals having different letter suffixes may represent different instances of similar components. The figures illustrate generally, by way of example, but not by way of limitation, various aspects discussed in the present document.

FIG. 1A illustrates an architecture of a network, in accordance with some aspects.

FIG. 1B and FIG. 1C illustrate a non-roaming 5G system architecture in accordance with some aspects.

FIG. 2 illustrates a reference diagram of an IAB architecture, in accordance with some aspects.

FIG. 3 illustrates a central unit (CU)—distributed unit (DU) split and signaling in an IAB architecture, in accordance with some aspects.

FIG. 4 illustrates IAB MT/DU simultaneous transmission or reception communication scenarios, in accordance with some aspects.

FIG. 5 illustrates an open-loop DL power control system, in accordance with some aspects.

FIG. 6 illustrates a closed-loop DL power control system, in accordance with some aspects.

FIG. 7 illustrates beam pair-based UL reference signal configuration, in accordance with some aspects.

FIG. 8 illustrates a block diagram of a communication device such as an evolved Node-B (eNB), a new generation Node-B (gNB), an access point (AP), a wireless station (STA), a mobile station (MS), or a user equipment (UE), in accordance with some aspects.

### DETAILED DESCRIPTION

The following description and the drawings sufficiently illustrate aspects to enable those skilled in the art to practice them. Other aspects may incorporate structural, logical, electrical, process, and other changes. Portions and features of some aspects may be included in or substituted for, those of other aspects. Aspects outlined in the claims encompass all available equivalents of those claims.

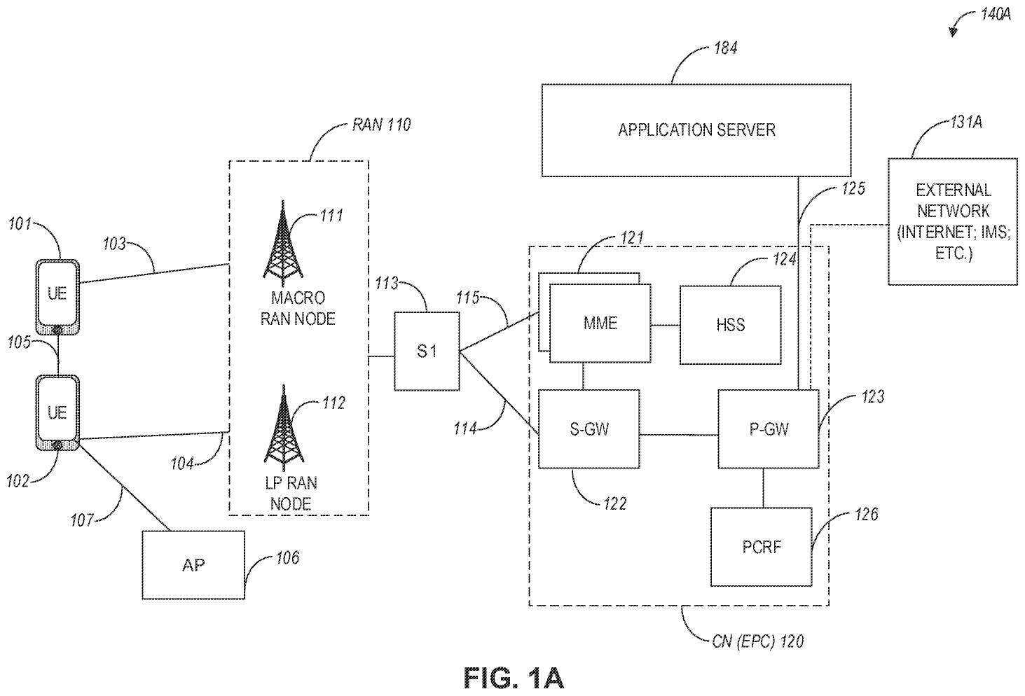

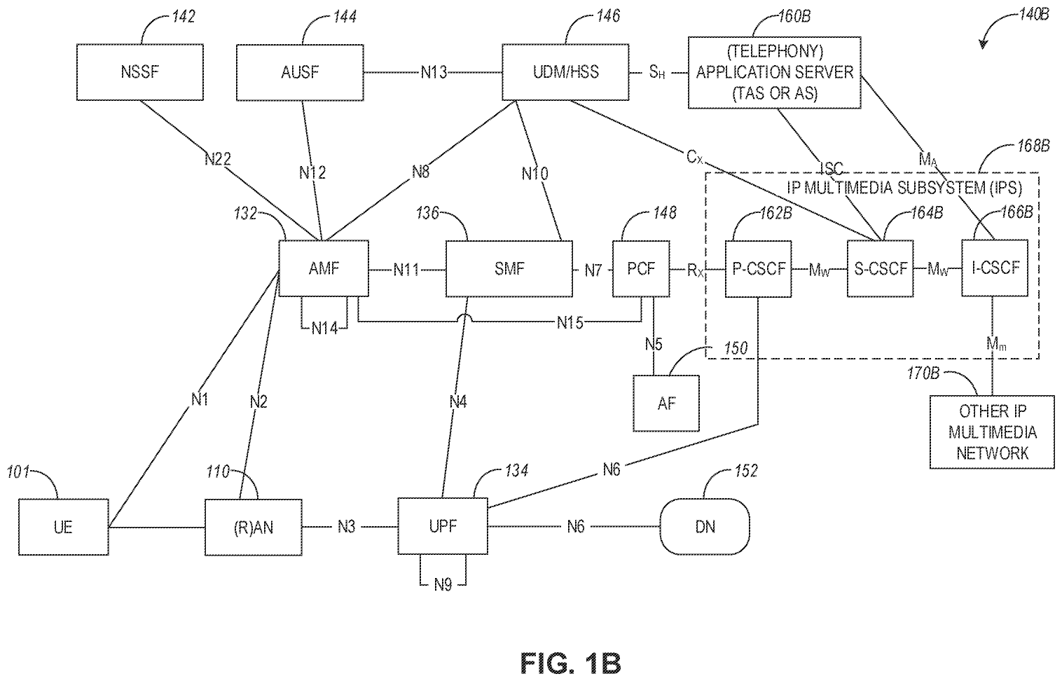

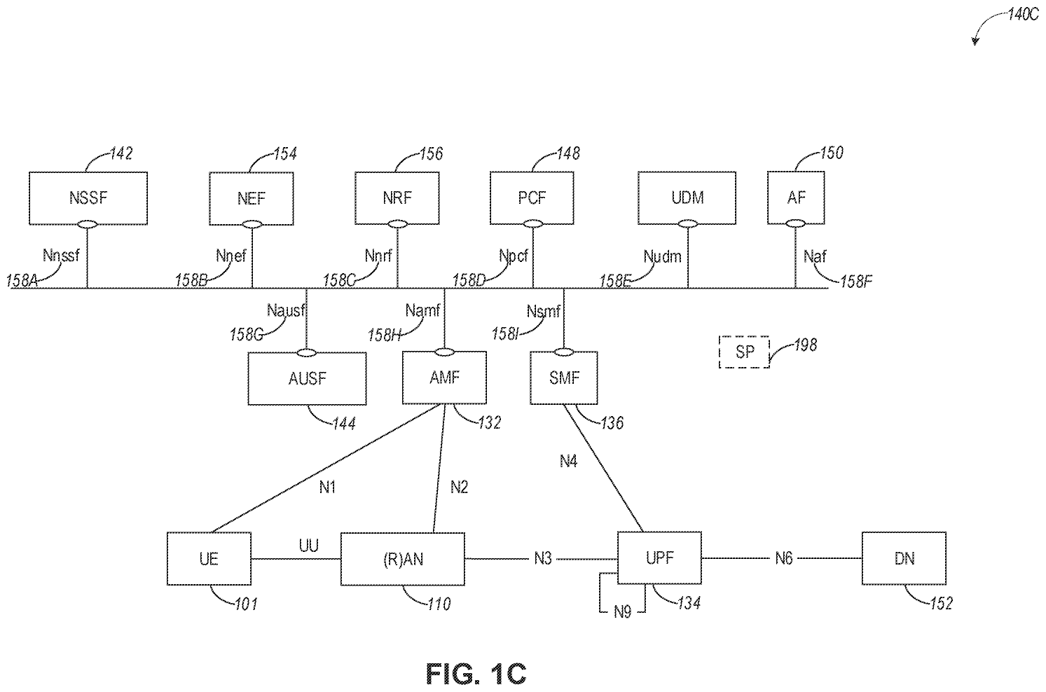

FIG. 1A illustrates an architecture of a network in accordance with some aspects. The network 140A is shown to include user equipment (UE) 101 and UE 102. The UEs 101 and 102 are illustrated as smartphones (e.g., handheld touchscreen mobile computing devices connectable to one or more cellular networks) but may also include any mobile or non-mobile computing device, such as Personal Data Assistants (PDAs), pagers, laptop computers, desktop computers, wireless handsets, drones, or any other computing device including a wired and/or wireless communications interface. The UEs 101 and 102 can be collectively referred to herein as UE 101, and UE 101 can be used to perform one or more of the techniques disclosed herein.

Any of the radio links described herein (e.g., as used in the network 140A or any other illustrated network) may operate according to any exemplary radio communication technology and/or standard.

LTE and LTE-Advanced are standards for wireless communications of high-speed data for UE such as mobile telephones. In LTE-Advanced and various wireless systems, carrier aggregation is a technology according to which multiple carrier signals operating on different frequencies may be used to carry communications for a single UE, thus increasing the bandwidth available to a single device. In some aspects, carrier aggregation may be used where one or more component carriers operate on unlicensed frequencies.

Aspects described herein can be used in the context of any spectrum management scheme including, for example, dedicated licensed spectrum, unlicensed spectrum, (licensed) shared spectrum (such as Licensed Shared Access (LSA) in 2.3-2.4 GHz, 3.4-3.6 GHz, 3.6-3.8 GHz, and further frequencies and Spectrum Access System (SAS) in 3.55-3.7 GHz and further frequencies).

Aspects described herein can also be applied to different Single Carrier or OFDM flavors (CP-OFDM, SC-FDMA, SC-OFDM, filter bank-based multicarrier (FBMC), OFDMA, etc.) and in particular 3GPP NR (New Radio) by allocating the OFDM carrier data bit vectors to the corresponding symbol resources.

In some aspects, any of the UEs 101 and 102 can comprise an Internet-of-Things (IoT) UE or a Cellular IoT (CIoT) UE, which can comprise a network access layer designed for low-power IoT applications utilizing short-lived UE connections. In some aspects, any of the UEs 101 and 102 can include a narowband (NB) IoT UE (e.g., such as an enhanced NB-IoT (eNB-IoT) UE and Further Enhanced (FeNB-IoT) UE). An IoT UE can utilize technologies such as machine-to-machine (M2M) or machine-type communications (MTC) for exchanging data with an MTC server or device via a public land mobile network (PLMN), Proximity-Based Service (ProSe), or device-to-device (D2D) communication, sensor networks, or IoT networks. The M2M or MTC exchange of data may be a machine-initiated exchange of data. An IoT network includes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network.

In some aspects, any of the UEs 101 and 102 can include enhanced MTC (eMTC) UEs or further enhanced MTC (FeMTC) UEs.

The UEs 101 and 102 may be configured to connect, e.g., communicatively couple, with a radio access network (RAN) 110. The RAN 110 may be, for example, an Evolved Universal Mobile Telecommunications System (UMTS) Terrestrial Radio Access Network (E-UTRAN), a NextGen RAN (NG RAN), or some other type of RAN. The UEs 101 and 102 utilize connections 103 and 104, respectively, each of which comprises a physical communications interface or layer (discussed in further detail below); in this example, connections 103 and 104 are illustrated as an air interface to enable communicative coupling and can be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a fifth-generation (5G) protocol, a New Radio (NR) protocol, and the like.

In an aspect, the UEs 101 and 102 may further directly exchange communication data via a ProSe interface 105. The ProSe interface 105 may alternatively be referred to as a sidelink interface comprising one or more logical channels, including but not limited to a Physical Sidelink Control Channel (PSCCH), a Physical Sidelink Shared Channel (PSSCH), a Physical Sidelink Discovery Channel (PSDCH), and a Physical Sidelink Broadcast Channel (PSBCH).

The UE 102 is shown to be configured to access an access point (AP) 106 via connection 107. The connection 107 can comprise a local wireless connection, such as, for example, a connection consistent with any IEEE 802.11 protocol, according to which the AP 106 can comprise a wireless fidelity (WiFi®) router. In this example, the AP 106 is shown to be connected to the Internet without connecting to the core network of the wireless system (described in further detail below).

The RAN 110 can include one or more access nodes that enable connections 103 and 104. These access nodes (ANs) can be referred to as base stations (BSs), NodeBs, evolved NodeBs (eNBs), Next Generation NodeBs (gNBs), RAN nodes, and the like, and can comprise ground stations (e.g., terrestrial access points) or satellite stations providing coverage within a geographic area (e.g., a cell). In some aspects, the communication nodes 111 and 112 can be transmission/reception points (TRPs). In instances when the communication nodes 111 and 112 are NodeBs (e.g., eNBs or gNBs), one or more TRPs can function within the communication cell of the NodeBs. The RAN 110 may include one or more RAN nodes for providing macrocells, e.g., macro RAN node 111, and one or more RAN nodes for providing femtocells or picocells (e.g., cells having smaller coverage areas, smaller user capacity, or higher bandwidth compared to macrocells), e.g., low power (LP) RAN node 112.

Any of the RAN nodes 111 and 112 can terminate the air interface protocol and can be the first point of contact for the UEs 101 and 102. In some aspects, any of the RAN nodes 111 and 112 can fulfill various logical functions for the RAN 110 including, but not limited to, radio network controller (RNC) functions such as radio bearer management, uplink and downlink dynamic radio resource management, and data packet scheduling, and mobility management. In an example, any of the nodes 111 and/or 112 can be a new generation Node-B (gNB), an evolved node-B (eNB), or another type of RAN node.

The RAN 110 is shown to be communicatively coupled to a core network (CN) 120 via an S1 interface 113. In aspects, the CN 120 may be an evolved packet core (EPC) network, a NextGen Packet Core (NPC) network, or some other type of CN (e.g., as illustrated in reference to FIGS. 1B-1C). In this aspect, the S1 interface 113 is split into two parts: the S1-U interface 114, which carries traffic data between the RAN nodes 111 and 112 and the serving gateway (S-GW) 122, and the S1-mobility management entity (MME) interface 115, which is a signaling interface between the RAN nodes 111 and 112 and MMEs 121.

In this aspect, the CN 120 comprises the MMEs 121, the S-GW 122, the Packet Data Network (PDN) Gateway (P-GW) 123, and a home subscriber server (HSS) 124. The MMEs 121 may be similar in function to the control plane of legacy Serving General Packet Radio Service (GPRS) Support Nodes (SGSN). The MMEs 121 may manage mobility aspects in access such as gateway selection and tracking area list management. The HSS 124 may comprise a database for network users, including subscription-related information to support the network entities' handling of communication sessions. The CN 120 may comprise one or several HSSs 124, depending on the number of mobile subscribers, the capacity of the equipment, the organization of the network, etc. For example, the HSS 124 can provide support for routing/roaming, authentication, authorization, naming/addressing resolution, location dependencies, etc.

The S-GW 122 may terminate the S1 interface 113 towards the RAN 110, and routes data packets between the RAN 110 and the CN 120. In addition, the S-GW 122 may be a local mobility anchor point for inter-RAN node handovers and also may provide an anchor for inter-3GPP mobility. Other responsibilities of the S-GW 122 may include lawful intercept, charging, and some policy enforcement.

The P-GW 123 may terminate an SGi interface toward a PDN. The P-GW 123 may route data packets between the EPC network 120 and external networks such as a network including the application server 184 (alternatively referred to as application function (AF)) via an Internet Protocol (IP) interface 125. The P-GW 123 can also communicate data to other external networks 131A, which can include the Internet, IP multimedia subsystem (IPS) network, and other networks. Generally, the application server 184 may be an element offering applications that use IP bearer resources with the core network (e.g., UMTS Packet Services (PS) domain, LTE PS data services, etc.). In this aspect, the P-GW 123 is shown to be communicatively coupled to an application server 184 via an IP interface 125. The application server 184 can also be configured to support one or more communication services (e.g., Voice-over-Internet Protocol (VoIP) sessions, PTT sessions, group communication sessions, social networking services, etc.) for the UEs 101 and 102 via the CN 120.

The P-GW 123 may further be a node for policy enforcement and charging data collection. Policy and Charging Rules Function (PCRF) 126 is the policy and charging control element of the CN 120. In a non-roaming scenario, in some aspects, there may be a single PCRF in the Home Public Land Mobile Network (HPLMN) associated with a UE's Internet Protocol Connectivity Access Network (IP-CAN) session. In a roaming scenario with a local breakout of traffic, there may be two PCRFs associated with a UE's IP-CAN session: a Home PCRF (H-PCRF) within an HPLMN and a Visited PCRF (V-PCRF) within a Visited Public Land Mobile Network (VPLMN). The PCRF 126 may be communicatively coupled to the application server 184 via the P-GW 123.

In some aspects, the communication network 140A can be an IoT network or a 5G network, including a 5G new radio network using communications in the licensed (5G NR) and the unlicensed (5G NR-U) spectrum. One of the current enablers of IoT is the narrowband-IoT (NB-IoT).

An NG system architecture can include the RAN 110 and a 5G network core (5GC) 120. The NG-RAN 110 can include a plurality of nodes, such as gNBs and NG-eNBs. The core network 120 (e.g., a 5G core network or 5GC) can include an access and mobility function (AMF) and/or a user plane function (UPF). The AMF and the UPF can be communicatively coupled to the gNBs and the NG-eNBs via NG interfaces. More specifically, in some aspects, the gNBs and the NG-eNBs can be connected to the AMF by NG-C interfaces, and to the UPF by NG-U interfaces. The gNBs and the NG-eNBs can be coupled to each other via Xn interfaces.

In some aspects, the NG system architecture can use reference points between various nodes as provided by 3GPP Technical Specification (TS) 23.501 (e.g., V15.4.0, 2018-12). In some aspects, each of the gNBs and the NG-eNBs can be implemented as a base station, a mobile edge server, a small cell, a home eNB, and so forth. In some aspects, a gNB can be a master node (MN) and NG-eNB can be a secondary node (SN) in a 5G architecture.

FIG. 1B illustrates a non-roaming 5G system architecture in accordance with some aspects. Referring to FIG. 1B, there is illustrated a 5G system architecture 140B in a reference point representation. More specifically, UE 102 can be in communication with RAN 110 as well as one or more other 5G core (5GC) network entities. The 5G system architecture 140B includes a plurality of network functions (NFs), such as access and mobility management function (AMF) 132, session management function (SMF) 136, policy control function (PCF) 148, application function (AF) 150, user plane function (UPF) 134, network slice selection function (NSSF) 142, authentication server function (AUSF) 144, and unified data management (UDM)/home subscriber server (HSS) 146. The UPF 134 can provide a connection to a data network (DN) 152, which can include, for example, operator services, Internet access, or third-party services. The AMF 132 can be used to manage access control and mobility and can also include network slice selection functionality. The SMF 136 can be configured to set up and manage various sessions according to network policy. The UPF 134 can be deployed in one or more configurations according to the desired service type. The PCF 148 can be configured to provide a policy framework using network slicing, mobility management, and roaming (similar to PCRF in a 4G communication system). The UDM can be configured to store subscriber profiles and data (similar to an HSS in a 4G communication system).

In some aspects, the 5G system architecture 140B includes an IP multimedia subsystem (IMS) 168B as well as a plurality of IP multimedia core network subsystem entities, such as call session control functions (CSCFs). More specifically, the IMS 168B includes a CSCF, which can act as a proxy CSCF (P-CSCF) 162BE, a serving CSCF (S-CSCF) 164B, an emergency CSCF (E-CSCF) (not illustrated in FIG. 1B), or interrogating CSCF (I-CSCF) 166B. The P-CSCF 162B can be configured to be the first contact point for the UE 102 within the IM subsystem (IMS) 168B. The S-CSCF 164B can be configured to handle the session states in the network, and the E-CSCF can be configured to handle certain aspects of emergency sessions such as routing an emergency request to the correct emergency center or PSAP. The I-CSCF 166B can be configured to function as the contact point within an operator's network for all IMS connections destined to a subscriber of that network operator, or a roaming subscriber currently located within that network operator's service area. In some aspects, the I-CSCF 166B can be connected to another IP multimedia network 170E, e.g. an IMS operated by a different network operator.

In some aspects, the UDM/HSS 146 can be coupled to an application server 160E, which can include a telephony application server (TAS) or another application server (AS). The AS 160B can be coupled to the IMS 168B via the S-CSCF 164B or the I-CSCF 166B.

A reference point representation shows that interaction can exist between corresponding NF services. For example, FIG. 1B illustrates the following reference points: N1 (between the UE 102 and the AMF 132), N2 (between the RAN 110 and the AMF 132), N3 (between the RAN 110 and the UPF 134), N4 (between the SMF 136 and the UPF 134), N5 (between the PCF 148 and the AF 150, not shown), N6 (between the UPF 134 and the DN 152), N7 (between the SMF 136 and the PCF 148, not shown), N8 (between the UDM 146 and the AMF 132, not shown), N9 (between two UPFs 134, not shown), N10 (between the UDM 146 and the SMF 136, not shown), N11 (between the AMF 132 and the SMF 136, not shown), N12 (between the AUSF 144 and the AMF 132, not shown), N13 (between the AUSF 144 and the UDM 146, not shown), N14 (between two AMFs 132, not shown), N15 (between the PCF 148 and the AMF 132 in case of a non-roaming scenario, or between the PCF 148 and a visited network and AMF 132 in case of a roaming scenario, not shown), N16 (between two SMFs, not shown), and N22 (between AMF 132 and NSSF 142, not shown). Other reference point representations not shown in FIG. 1B can also be used.

FIG. 1C illustrates a 5G system architecture 140C and a service-based representation. In addition to the network entities illustrated in FIG. 1B, system architecture 140C can also include a network exposure function (NEF) 154 and a network repository function (NRF) 156. In some aspects, 5G system architectures can be service-based and interaction between network functions can be represented by corresponding point-to-point reference points Ni or as service-based interfaces.

In some aspects, as illustrated in FIG. 1C, service-based representations can be used to represent network functions within the control plane that enable other authorized network functions to access their services. In this regard, 5G system architecture 140C can include the following service-based interfaces: Namf 158H (a service-based interface exhibited by the AMF 132), Nsmf 1581 (a service-based interface exhibited by the SMF 136), Nnef 158B (a service-based interface exhibited by the NEF 154), Npcf 158D (a service-based interface exhibited by the PCF 148), a Nudm 158E (a service-based interface exhibited by the UDM 146), Naf 158F (a service-based interface exhibited by the AF 150), Nnrf 158C (a service-based interface exhibited by the NRF 156), Nnssf 158A (a service-based interface exhibited by the NSSF 142), Nausf 158G (a service-based interface exhibited by the AUSF 144). Other service-based interfaces (e.g., Nudr, N5g-eir, and Nudsf) not shown in FIG. 1C can also be used.

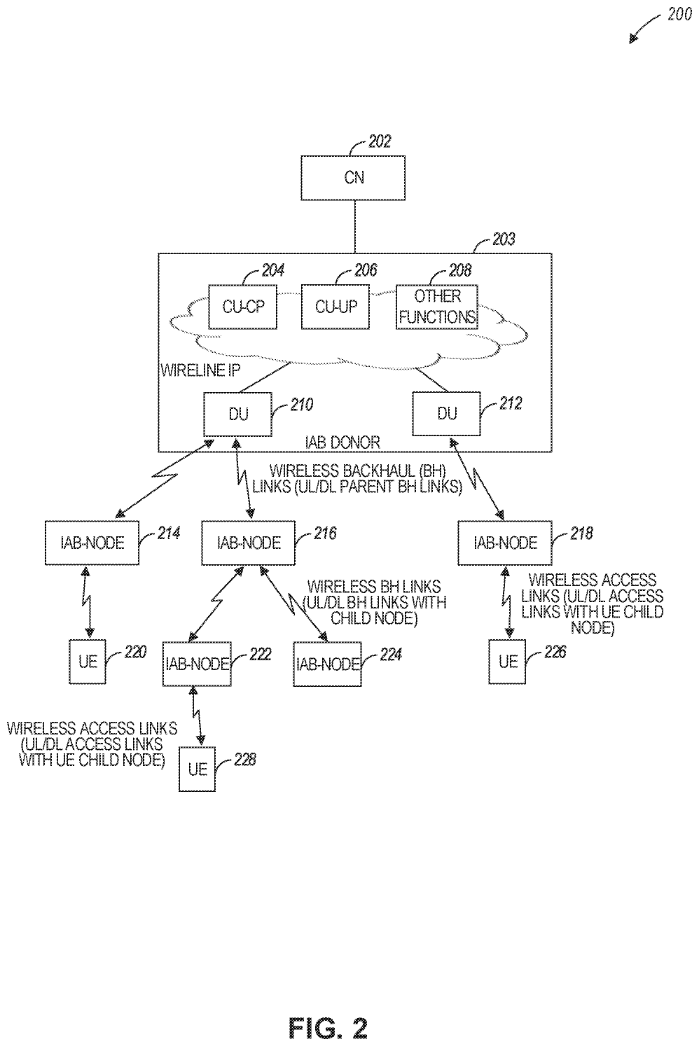

Techniques discussed herein can be performed by a UE, a base station (e.g., any of the UEs or base stations discussed in connection with FIG. 1A-FIG. 1C), or any of the nodes in the Integrated Access and Backhaul (IAB) communication systems discussed in connection with FIGS. 2-8.

For an IAB node, the IAB distributed unit (DU) function may operate with multiple cells by using multiple component carriers (CCs) and/or multiple antenna panels. On the other hand, the co-located IAB mobile termination (MT) function can work under different CCs with carrier aggregation for a backhaul link. In some aspects, the IAB donor node central unit (CU) function and the parent node can be aware of the multiplexing capability between the MT and the DU functions (e.g., time-division multiplexing (TDM) is required or TDM is not required) of an IAB node for any {MT CC, DU cell} pair. Techniques discussed herein use signaling contents, signaling mechanisms, and detailed signaling methods to communicate an IAB node's multiplexing capability to the donor CU and the parent node.

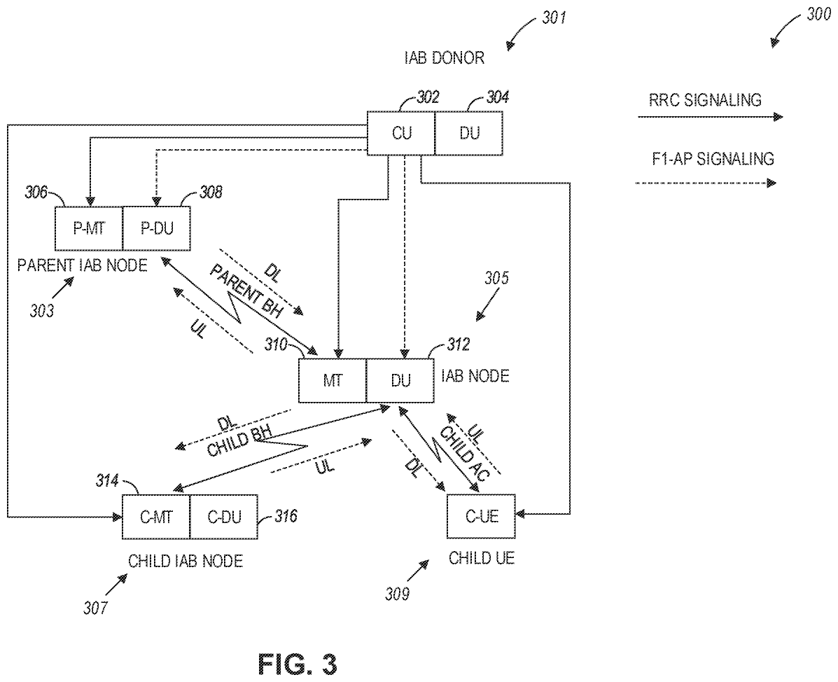

As illustrated in FIGS. 2-3, in an IAB network, an IAB node can connect to its parent node (an IAB donor or another IAB node) through a parent backhaul (BH) link, connect to a child user equipment (UE) through a child access (AC) link, and connect to a child IAB node through a child BH link.

FIG. 2 shows a reference diagram for IAB in a standalone mode, which contains one IAB donor node 203 and multiple IAB nodes (e.g., 214, 216, 218, 222, and 224). Referring to FIG. 2, the IAB architecture 200 can include a core network (CN) 202 coupled to an IAB donor node 203. The IAB donor node 203 can include control unit control plane (CU-CP) function 204, control unit user plane (CU-UP) function 206, other functions 208, and distributed unit (DU) functions 210 and 212. The DU function 210 can be coupled via wireless backhaul links to IAB nodes 214 and 216. The DU function 212 is coupled via a wireless backhaul link to IAB node 218. IAB node 214 is coupled to a UE 220 via a wireless access link, and IAB node 216 is coupled to IAB nodes 222 and 224. The IAB node 222 is coupled to UE 228 via a wireless access link. The IAB node 218 is coupled to UE 226 via a wireless access link.

Each of the IAB nodes illustrated in FIG. 2 can include a mobile termination (MT) function and a DU function. The MT function can be defined as a component of the mobile equipment and can be referred to as a function residing on an IAB node that terminates the radio interface layers of the backhaul Uu interface toward the IAB donor or other IAB nodes.

The IAB donor 203 is treated as a single logical node that comprises a set of functions such as gNB-DU, gNB-CU-CP 204, gNB-CU-UP 206, and potentially other functions 208. In deployment, the IAB donor 203 can be split according to these functions, which can all be either collocated or non-collocated as allowed by 3GPP NG-RAN architecture. IAB-related aspects may arise when such a split is exercised. In some aspects, some of the functions presently associated with the IAB donor may eventually be moved outside of the donor in case it becomes evident that they do not perform IAB-specific tasks.

FIG. 3 illustrates a central unit (CU)-distributed unit (DU) split and signaling in an IAB architecture 300, in accordance with some aspects. Referring to FIG. 3, the IAB architecture 300 includes an IAB donor 301, a parent IAB node 303, an IAB node 305, a child IAB node 307, and a child UE 309. The IAB donor 301 includes a CU function 302 and a DU function 304. The parent IAB node 303 includes a parent MT (P-MT) function 306 and a parent DU (P-DU) function 308. The IAB node 305 includes an MT function 310 and a DU function 312. The child IAB node 307 includes a child MT (C-MT) function 314 and a child DU (C-DU) function 316.

As illustrated in FIG. 3, RRC signaling can be used for communication between the CU function 302 of the IAB donor 301 and the MT functions 306, 310, and 314, as well as between the CU function 302 and the child UE (C-UE) 309. Additionally, F1 access protocol (F1AP) signaling can be used for communication between the CU function 302 of the IAB donor 301 and the DU functions of the parent IAB node 303 and the IAB node 305.

As illustrated in FIGS. 2-3, multiple IAB nodes are connected to a donor node (DN) via a wireless backhaul. A DN or a parent IAB node needs to properly allocate resources for its child IAB node under the half-duplex constraint at the child IAB node. In some aspects, the time-frequency resource allocated to the parent link may be orthogonal to the time-frequency resource allocated to the child or access link.

In an example IAB network architectures (e.g., as illustrated in FIG. 2 and FIG. 3), CU/DU split has been leveraged where each IAB node holds a DU and an MT function. Via the MT function, the IAB node connects to its parent IAB node or the IAB-donor like a UE. Via the DU function, the IAB node communicates with its child UEs and child MTs like a base station. In some aspects, RRC signaling is used between the CU in the IAB donor and the UEMT, while F1AP signaling is used between the CU and the DU in an IAB node.

FIG. 3 illustrates an example of the IAB CU/DU split architecture and signaling, where MT and DU in a parent IAB node are indicated as P-MT/P-DU, and MT and DU in a child IAB node are indicated as C-MT/C-DU, and a child UE is indicated as C-UE.

In some embodiments, a TDM-based DU function and an MT function may be supported within an IAB node. Extended IAB functionalities include duplexing enhancements to increase spectral efficiency and reduce latency through the support of SDM/FDM-based resource management, through simultaneous transmissions, and/or reception on IAB-nodes.

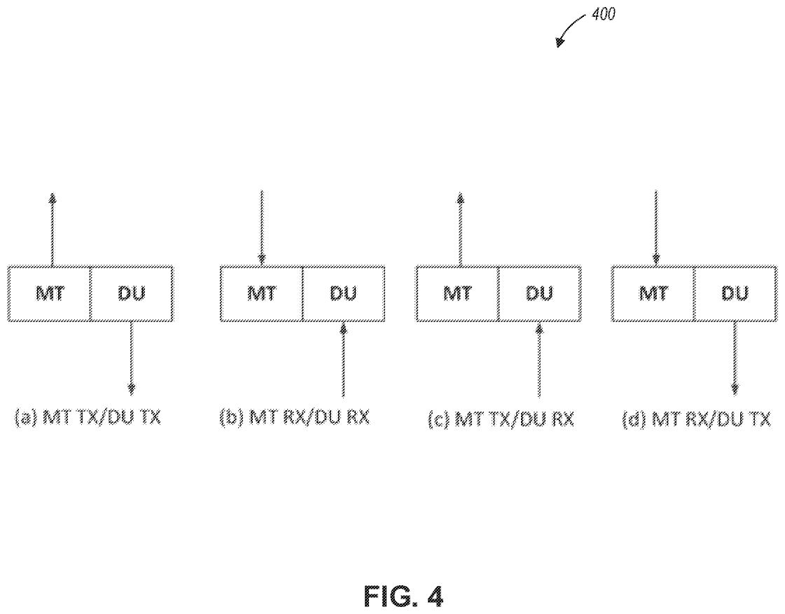

FIG. 4 illustrates IAB MT/DU simultaneous transmission or reception communication scenarios 400, in accordance with some aspects. In some embodiments, simultaneous operation (transmission and/or reception) of IAB-node's child and parent links includes four cases as below (illustrated in FIG. 4):
(a) MT TX/DU TX
(b) MT RX/DU RX
(c) MT TX/DU RX
(d) MT RX/DU TX

In some embodiments, if IAB MT/DU simultaneous transmission is allowed, there will be additional power control demands other than UL power control. For example, in FIG. 4 case(b), an IAB MT function is receiving from its parent DU and the co-located DU is receiving from its child. Since DL transmission usually has higher equivalent isotropic radiated power (EIRP) than the UL transmission, there will be a high chance that MT received power will be much higher than the co-located DU received power (un-balanced receiving power), which will cause high interference. Since UL transmission power is limited by the UE/MT capability, UL power control in the current specification may not fully solve this issue. Hence, DL power control (MT informs its parent DU to adjust its DL transmission power) is needed for IAB backhaul.

In some aspects, the disclosed IAB backhaul DL power control mechanisms can be applied not limited to support IAB MT/DU simultaneous transmission scenarios.

The disclosed techniques include IAB backhaul DL power control mechanisms which can be applied for different DL channels and DL signals (e.g., PDCCH, PDSCH, etc.)

Mechanism A: Open-loop DL Power Control Mechanism

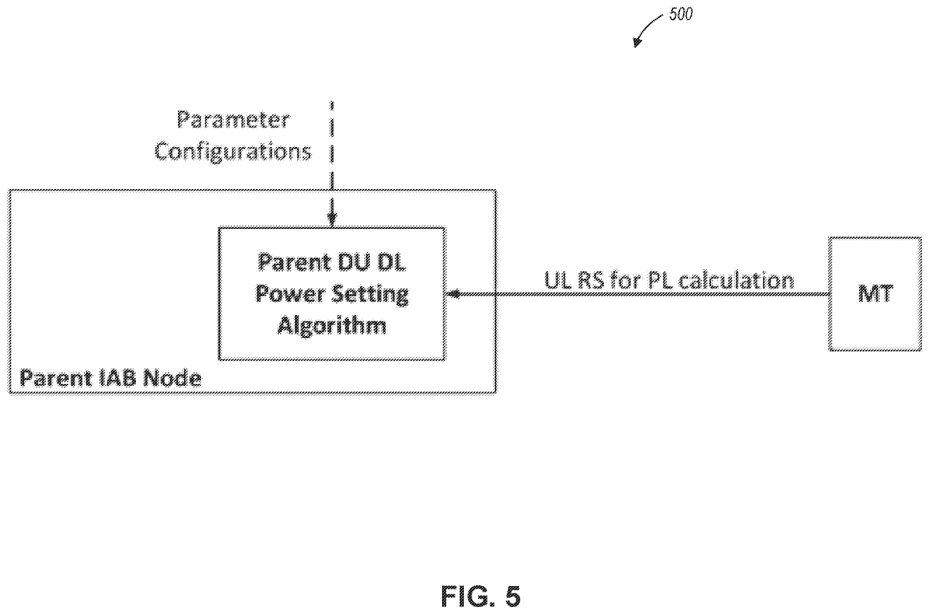

FIG. 5 illustrates an open-loop DL power control system 500, in accordance with some aspects. In the open-loop DL power control mechanism illustrated in FIG. 5, the parent DU's DL transmission power setting algorithm in the parent IAB node may be based on some configured parameters and a UL reference signal (RS) measurement for path loss (PL) calculation.

In some embodiments, the parameter configurations can include at least one UL reference signal power, target DL reception power, and fractional path-loss compensation factor.

For example, a DL transmission power can be determined on and active DL bandwidth part (BWP) b of carrier f of serving cell c in transmission occasion i as:

P_{DL,b,f,c}(i)=min {P_{DMAx,f,c}(i),P_{DLtarget,b,f,c}+α_{b,f,c}·PL_{b,f,c}}, (I)

where P_{DMAX,f,c}(i) is the parent DU's configured maximum output power for carrier f of serving cell c in transmission occasion i; P_{DL,target,b,f,c} is the DL target reception power according to parameter configurations for the active DL BWP b of carrier f of serving cell c; α_{b,f,c} is the open-loop fractional path-loss compensation factor for the active DL BWP b of carrier f of serving cell c; and PL_{b,f,c} is the path loss for the active DL BWP b of carrier f of serving cell c based on the associated UL RS measurement. In some embodiments, the path loss may be calculated by UL reference signal power according to parameter configurations and UL RS reception measurements.

Mechanism B: Closed-Loop DL Power Control Mechanism

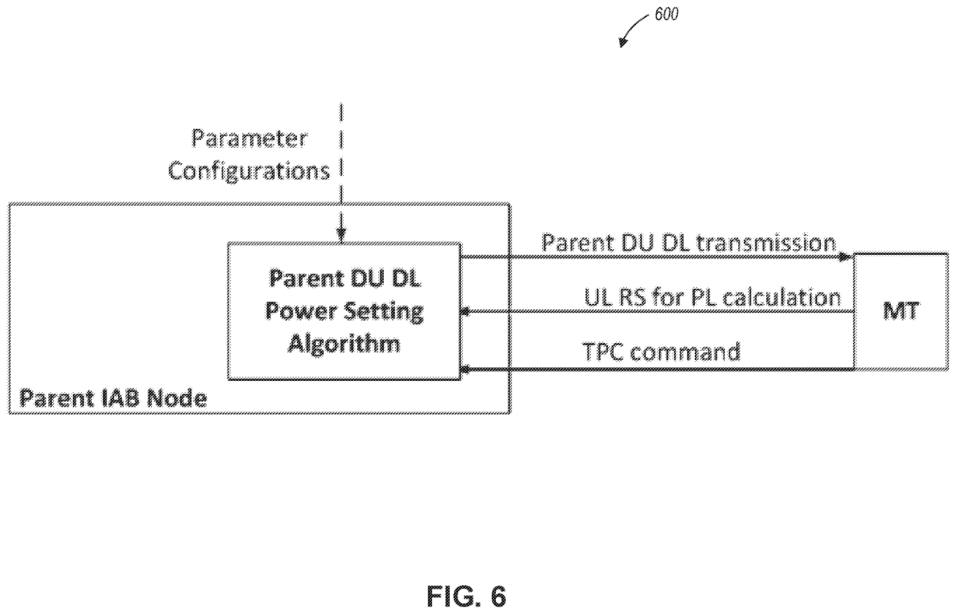

FIG. 6 illustrates a closed-loop DL power control system 600, in accordance with some aspects. In a closed-loop DL power control mechanism (illustrated in FIG. 6), there may be an additional transmit power control (TPC) command transmitted from the MT function to the parent DU function according to parent DU's DL transmission, compared with open-loop DL power control. The parent DU's DL transmission power setting algorithm in the parent IAB node may be based on configured parameters, UL reference signal (RS) measurement for path loss (PL) calculation, and the TPC command.

In some embodiments, the parameter configurations used for DL power control may include:

(a) UL reference signal power set with each UL RS in the set being associated with a specific value of q, corresponding to a beam pair path; q=1, . . . , Q; and

(b) Open-loop fractional path-loss compensation parameter set including target DL reception power and fractional path-loss compensation factor pair (P_{target}(j), α(j)), j=0, 1, . . . , j.

For example, a DL transmission power can be determined as Equation (2), for an active DL BWP b, carrier f, serving cell c, and open-loop based on:

(a) fractional path-loss compensation index j. For open-loop power control supporting fractional path-loss compensation parameter pairs (expression of P_{target}+α·PL), there may be different open-loop fractional path-loss compensation parameter pairs (P_{target}(j),α(j)).

(b) closed-loop process index l. Multiple independent closed-loop DL power control processes can be allowed. For example, if two closed-loop processes are allowed, they can be associated with l=1 and l=2, respectively.

(c) DL transmission occasion i.

(d) Beam pair index q. In some embodiments, there may exist multiple beam pairs between MT and its parent DU, hence the parent IAB node needs to retain multiple path-loss estimates, corresponding to different candidate beam pairs. Those path-loss estimates are based on measurements on different UL RSs. Each RS is being associated with a specific value of q.

In some embodiments, the DL power control may be based on the following Equation (2) for the DL transmit power:

P_{DL,b,f,c}(i,j,q,l)=min {P_{DMAx,f,c}(i),P_{DLtarget,b,f,c}(j)+a_{b,f,c}(j)·PL_{b,f,c}(q)+10·log₁₀(2^{μ}·M_{RB,b,f,c}(i))+Δ_{TF,b,f,c}(i)+g_{TPc,b,f,c}(i,l)}, (2)

where P_{DMAX,f,c}(i) is the parent DU's configured maximum output power for carrier f of serving cell c in transmission occasion i; P_{DL,target,f,c}(j) is the DL target reception power according to parameter configurations for the active DL BWP b, carrier f, serving cell c and open-loop fractional path-loss compensation index j; α_{b,f,c}(j) is the open-loop fractional path-loss compensation factor for the active DL BWP b, carrier f, serving cell c with index j; and PL_{b,f,c}(q) is the path loss for the active DL BWP b of carrier f of serving cell c based on the associated UL RS index q measurement. In some embodiments, the DL transmit power may be calculated by the UL RS power with index q according to parameter configurations and the corresponding UL RS reception measurements. Equation (2) may also be based on μ relates to the subcarrier spacing used for the DL transmission, Δf=2^{μ}·15 kHz; M_{RB,b,f,c}(i) is the number of resource blocks assigned for the DL transmission for the active DL BWP b, carrier f, serving cell c in transmission occasion i; A_{TF,b,f,c}(i) is related to the modulation scheme and channel-coding rate used for the DL transmission for the active DL BWP b, carrier f, serving cell c in transmission occasion i; and T_{PC,b,f,c}(i, l) is the power adjustment due to the closed-loop TPC command for the active DL BWP b, carrier f, serving cell c in transmission occasion i, with closed-loop process index l.

UL Reference Signal for IAB Backhaul DL Power Control

In some embodiments, regarding UL reference signal for an JAB parent node to calculate the path loss for IAB backhaul DL power control purpose, there can be several options for the UL reference signal, as follows:

(a) Option 1: Sounding Reference Signal (SRS);
(b) Option 2: Demodulation Reference Signal (DMRS);
(c) Option 3: Use Physical Random Access Channel (PRACH); and
(d) Option 4: Define a new reference signal specifically for IAB backhaul DL power control.

In some embodiments, Options 1-3 apply reference signals/channels defined in an NR specification for the new LAB backhaul DL power control purpose. In some embodiments, Option 4 defines a new RS specifically for IAB backhaul DL power control, DPC-RS (downlink power control reference signal) for example.

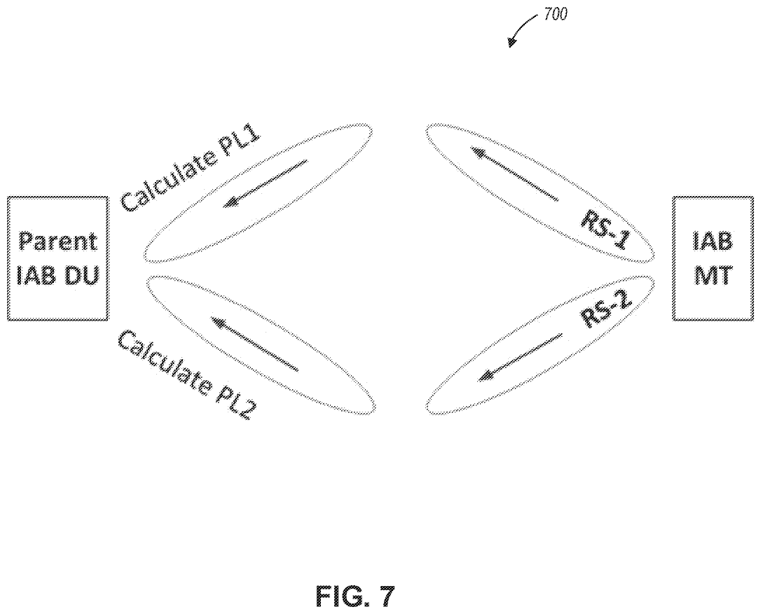

FIG. 7 illustrates beam pair-based UL reference signal configuration 700, in accordance with some aspects.

In some embodiments, Note that all the reference signals/channels to calculate the path loss should support beam-pair-based IAB DL power control. Assuming beam correspondence, the parent DU will estimate the downlink path loss based on measurements on a UL reference signal transmitted over the corresponding uplink beam pair. The parent DU may need to retain multiple path-loss estimates, corresponding to different candidate beam pairs, i.e., conduct path-loss estimates based on measurements on different UL RSs (as illustrated in FIG. 7).

UL Signaling to Carry TPC for IAB Backhaul DL Power Control

Regarding the TPC command to indicate closed-loop backhaul DL power control, it can take 2-4 bits (can be further extended) with certain power adjust steps and range. Each TPC command field is corresponding to a pre-defined power adjustment value. Example TPC commands are illustrated in Table 1 with 3 bits in the TPC command and the corresponding power adjustment value.

TABLE 1
TPC command field with corresponding power adjustment value.

| TPC command | Value (in dB) |
|---|---|
| 0 | −8 |
| 1 | −6 |
| 2 | −4 |
| 3 | −2 |
| 4 | 0 |
| 5 | 2 |
| 6 | 4 |
| 7 | 6 |

Regarding the UL signaling to carry the TPC command for IAB backhaul DL power control purpose, UL L1/L2 signaling from an IAB MT to its parent IAB DU with the following options can be applied.

(a) Option 1; Over UCI/PUCCH

For Option 1, the TPC transmission for IAB backhaul DL power control is over uplink control information (UCI) from the IAB MT to the parent IAB DU. A new field may be added in one of the current uplink control information (UCI) formats or add a new UCI format if the new field cannot be added in current UCI formats, and can be carried by physical uplink control channel (PUCCH). The PUCCH resource used to carry the new UCI type may be semi-statically configured or based on semi-persistent scheduling or dynamic scheduling.

(b) Option 2: Over MAC CE/PUSCH

For Option 2, the TPC transmission for IAB backhaul DL power control is over medium access control (MAC) control element (CE) carried by physical uplink shared channel (PUSCH), which can be either dynamic triggered or configured grant.

In some embodiments, the logic channel ID (LCID) field which identifies the logical channel instance of the corresponding MAC service data unit (SDU) or the type of the corresponding MAC CE or padding for the uplink shared channel (UL-SCH) is described in the following Table 2 with LCID values for UL-SCH. In some embodiments, one of the reserved LCID (35-39) may be used for transmitting the TPC command for IAB backhaul DL power control from an IAB MT to its parent DU.

TABLE 2

| Index | LCID values |
|---|---|
| 0 | CCCH of size 64 bits (referred to |
| | as “CCCH1” in TS 38.331 [5]) |
| 1-32 | Identity of the logical channel |
| 33 | Extended logical channel ID field |
| | (two-octet eLCID field) |
| 34 | Extended logical channel ID field |
| | (one-octet eLCID field) |
| 35-39 | Reserved |
| 40 | Sidelink Configured Grant |
| | Confirmation |
| 41 | Truncated Sidelink BSR |
| 42 | Sidelink BSR |
| 43 | Multiple Entry Configured Grant |
| | Confirmation |
| 44 | LBT failure (four octets) |
| 45 | LBT failure (one octet) |
| 46 | SCell BFR (four octets Ci) |
| 47 | SCell BFR (one octet Ci) |
| 48 | Truncated SCell BFR (four octets |
| | Ci) |
| 49 | Truncated SCell BFR (one octet |
| | Ci) |
| 50 | Number of Desired Guard |
| | Symbols |
| 51 | Pre-emptive BSR |
| 52 | CCCH of size 48 bits (referred to |
| | as “CCCH” in TS 38.331 [5]) |
| 53 | Recommended bit rate query |
| 54 | Multiple Entry PHR (four octets |
| | Ci) |
| 55 | Configured Grant Confirmation |
| 56 | Multiple Entry PHR (one octet Ci) |
| 57 | Single Entry PHR |
| 58 | C-RNTI |
| 59 | Short Truncated BSR |
| 60 | Long Truncated BSR |
| 61 | Short BSR |
| 62 | Long BSR |
| 63 | Padding |

(c) Option 3—Over a New Defined L1 Channel

For Option 3, in some embodiments, the TPC command for IAB backhaul DL power control may be transmitted over an L1 channel.

Signaling to Carry Parameter Configurations for IAB Backhaul DL Power Control

As discussed hereinabove, for open-loop and closed-loop DL power control mechanisms, parameter configurations for an IAB parent node may include UL reference signal power, target DL reception power, etc. Regarding the signaling to carry parameter configurations for IAB backhaul DL power control, there can be several methods as follows.

Method A: UL L1/L2 Signaling from an IAB MT to its Parent IAB DU

In this method A, L1/L2 signaling from an IAB MT to its parent IAB DU is utilized to carry parameter configurations for IAB backhaul DL power control. There can be similar options as discussed hereinabove:
(a) Option A1: Over UCI/PUCCH;
(b) Option A2: Over MAC CE/PUSCH; and
(c) Option A3: Over a new defined L1 channel.

Method B: F1AP Signaling from the CU to the Parent IAB DU

In this method B, F1AP signaling from the CU to the parent IAB DU is utilized to carry parameter configurations for IAB backhaul DL power control. There can be several F1AP signaling enhancement embodiment options as follows. In some embodiments, the embodiment options can be further extended to other F1AP messages (not limited to those options listed below):

(a) Option B1: Enhancement of the existing GNB-DU RESOURCE COORDINATION REQUEST F1AP message;

(b) Option B2: Enhancement of the existing GNB-CU CONFIGURATION UPDATE F1AP message; and

(c) Option B3: Introduction of a new dedicated F1AP message.

Method C: RRC Signaling from the CU to the Parent IAB MT

In this method C, RRC signaling from the CU to the parent IAB MT is utilized to carry parameter configurations for IAB back-haul DL power control. There can be several RRC signaling enhancement embodiment options as follows. In some aspects, the embodiment options can be further extended to other RRC messages (not limited to those options listed below):
(a) Option C1: Enhancement of existing RRC IE PDSCH-Config;
(b) Option C2: Enhancement of existing RRC IE PDCCH-Config;
(c) Option C3: Enhancement of existing RRC IE ServingCellConfig;
(d) Option C4: Enhancement of existing RRC IE ServingCellConfigCommon;
(e) Option C5: Enhancement of existing RRC IE ServingCellConfigCommonSIB; and
(f) Option C6: Introduce a new RRC message.

Method D: RRC Signaling from the IAB MT to the CU Regarding its Parent Nodes' Parameter Configurations

As in method B and method C, the parameter configurations are indicated from the CU. Hence, if the CU does not have the information or needs an update, the IAB node needs to inform the CU of those parameter configurations regarding its parent DU's DL transmission. Method D and Method E are proposed to facilitate this purpose.

In Method D, RRC signaling from the IAB MT to the CU is utilized to carry its parent node's parameter configuration of DL transmission power control. There can be several RRC signaling enhancement embodiment options as follows. In some aspects, the embodiment options can be further extended to other RRC messages (not limited to those options listed below):
(a) Option D1: Enhancement of existing RRC IE UECapabilityInformation;
(b) Option D2: Enhancement of existing RRC IE UL-DCCH-MessageType;
(c) Option D3: Enhancement of existing RRC IE UL-CCCH-MessageType;
(d) Option D4: Enhancement of existing RRC IE UL-CCCH1-MessageType;
(e) Option D5: Enhancement of existing RRC IE UEAssistanceInformation; and
(f) Option D6: Introduce a new RRC message.

Method E: F1AP Signaling from the IAB DU to the CU Regarding its Parent Nodes' Parameter Configurations

In Method E, F1AP signaling from an IAB DU to the CU is utilized to carry its parent node's parameter configuration of DL transmission power control. There can be several F1AP signaling enhancement embodiment options as follows. In some aspects, the embodiment options can be further extended to other F1AP messages (not limited to those options listed below):
(a) Option E1: Enhancement of existing GNB-DU RESOURCE COORDINATION RESPONSE F1AP message;
(b) Option E2: Enhancement of existing GNB-DU CONFIGURATION UPDATE F1AP message;
(c) Option E3: Enhancement of existing GNB-CU CONFIGURATION UPDATE ACKNOWLEDGE F1AP message; and
(d) Option E4: Introduction of a new dedicated F1AP message.

In some embodiments, combinations of the proposed methods may be used as well. For example, Method A combined with Method B (part of parameter configurations indicated by UL L1/L2 signaling from IAB MT; and part of parameter configurations indicated by F1AP from the CU to the parent DU); or Method B combined with Method D may be used (e.g., RRC signaling transmitted from an IAB MT to the CU; and then F1AP signaling from the CU to the parent DU).

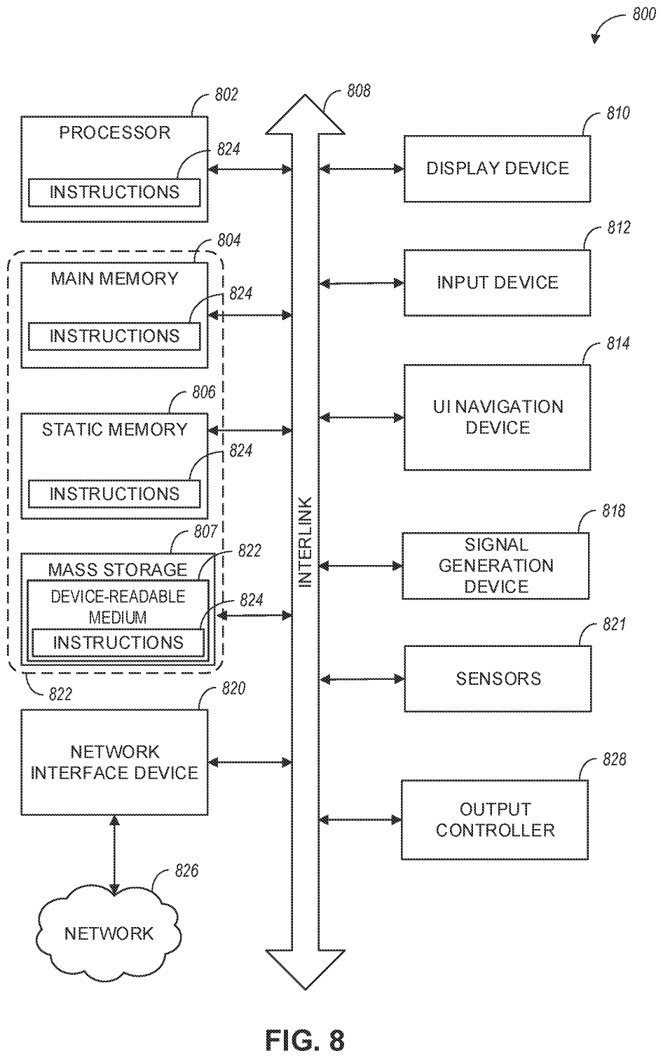

FIG. 8 illustrates a block diagram of a communication device such as an evolved Node-B (eNB), a next generation Node-B (gNB), an access point (AP), a wireless station (STA), a mobile station (MS), or a user equipment (UE), in accordance with some aspects and to perform one or more of the techniques disclosed herein. In alternative aspects, the communication device 800 may operate as a standalone device or may be connected (e.g., networked) to other communication devices.

Circuitry (e.g., processing circuitry) is a collection of circuits implemented in tangible entities of the device 800 that include hardware (e.g., simple circuits, gates, logic, etc.). Circuitry membership may be flexible over time. Circuitries include members that may, alone or in combination, perform specified operations when operating. In an example, the hardware of the circuitry may be immutably designed to carry out a specific operation (e.g., hardwired). In an example, the hardware of the circuitry may include variably connected physical components (e.g., execution units, transistors, simple circuits, etc.) including a machine-readable medium physically modified (e.g., magnetically, electrically, moveable placement of invariant massed particles, etc.) to encode instructions of the specific operation.

In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, in an example, the machine-readable medium elements are part of the circuitry or are communicatively coupled to the other components of the circuitry when the device is operating. For example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time. Additional examples of these components with respect to the device 800 follow.

In some aspects, the device 800 may operate as a standalone device or may be connected (e.g., networked) to other devices. In a networked deployment, the communication device 800 may operate in the capacity of a server communication device, a client communication device, or both in server-client network environments. In an example, the communication device 800 may act as a peer communication device in a peer-to-peer (P2P) (or other distributed) network environment. The communication device 800 may be a UE, eNB, PC, a tablet PC, an STB, a PDA, a mobile telephone, a smartphone, a web appliance, a network router, switch or bridge, or any communication device capable of executing instructions (sequential or otherwise) that specify actions to be taken by that communication device. Further, while only a single communication device is illustrated, the term “communication device” shall also be taken to include any collection of communication devices that individually or jointly execute a set (or multiple sets) of instructions to perform any one or more of the methodologies discussed herein, such as cloud computing, software as a service (SaaS), and other computer cluster configurations.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client, or server computer system) or one or more hardware processors may be configured by firmware or software (e.g., instructions, an application portion, or an application) as a module that operates to perform specified operations. For example, the software may reside on a communication device-readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using the software, the general-purpose hardware processor may be configured as respective different modules at different times. The software may accordingly configure a hardware processor, for example, to constitute a particular module at one instance of time and to constitute a different module at a different instance of time.

The communication device (e.g., UE) 800 may include a hardware processor 802 (e.g., a central processing unit (CPU), a graphics processing unit (GPU), a hardware processor core, or any combination thereof), a main memory 804, a static memory 806, and storage device 807 (e.g., hard drive, tape drive, flash storage, or other block or storage devices), some or all of which may communicate with each other via an interlink (e.g., bus) 808.

The communication device 800 may further include a display device 810, an alphanumeric input device 812 (e.g., a keyboard), and a user interface (UI) navigation device 814 (e.g., a mouse). In an example, the display device 810, input device 812, and UI navigation device 814 may be a touchscreen display. The communication device 800 may additionally include a signal generation device 818 (e.g., a speaker), a network interface device 820, and one or more sensors 821, such as a global positioning system (GPS) sensor, compass, accelerometer, or another sensor. The communication device 800 may include an output controller 828, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 807 may include a communication device-readable medium 822, on which is stored one or more sets of data structures or instructions 824 (e.g., software) embodying or utilized by any one or more of the techniques or functions described herein. In some aspects, registers of the processor 802, the main memory 804, the static memory 806, and/or the storage device 807 may be, or include (completely or at least partially), the device-readable medium 822, on which is stored the one or more sets of data structures or instructions 824, embodying or utilized by any one or more of the techniques or functions described herein. In an example, one or any combination of the hardware processor 802, the main memory 804, the static memory 806, or the mass storage 816 may constitute the device-readable medium 822.

As used herein, the term “device-readable medium” is interchangeable with “computer-readable medium” or “machine-readable medium”. While the communication device-readable medium 822 is illustrated as a single medium, the term “communication device-readable medium” may include a single medium or multiple media (e.g., a centralized or distributed database, and/or associated caches and servers) configured to store one or more instructions 824. The term “communication device-readable medium” is inclusive of the terms “machine-readable medium” or “computer-readable medium”, and may include any medium that is capable of storing, encoding, or carrying instructions (e.g., instructions 824) for execution by the communication device 800 and that cause the communication device 800 to perform any one or more of the techniques of the present disclosure, or that is capable of storing, encoding or carrying data structures used by or associated with such instructions. Non-limiting communication device-readable medium examples may include solid-state memories and optical and magnetic media. Specific examples of communication device-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, communication device-readable media may include non-transitory communication device-readable media. In some examples, communication device-readable media may include communication device-readable media that is not a transitory propagating signal.

The instructions 824 may further be transmitted or received over a communications network 826 using a transmission medium via the network interface device 820 utilizing any one of a number of transfer protocols. In an example, the network interface device 820 may include one or more physical jacks (e.g., Ethernet, coaxial, or phone jacks) or one or more antennas to connect to the communications network 826. In an example, the network interface device 820 may include a plurality of antennas to wirelessly communicate using at least one of single-input-multiple-output (SIMO), MIMO, or multiple-input-single-output (MISO) techniques. In some examples, the network interface device 820 may wirelessly communicate using Multiple User MIMO techniques.

The term “transmission medium” shall be taken to include any intangible medium that is capable of storing, encoding, or carrying instructions for execution by the communication device 800, and includes digital or analog communications signals or another intangible medium to facilitate communication of such software. In this regard, a transmission medium in the context of this disclosure is a device-readable medium.

Although an aspect has been described with reference to specific exemplary aspects, it will be evident that various modifications and changes may be made to these aspects without departing from the broader scope of the present disclosure. Accordingly, the specification and drawings are to be regarded in an illustrative rather than a restrictive sense. This Detailed Description, therefore, is not to be taken in a limiting sense, and the scope of various aspects is defined only by the appended claims, along with the full range of equivalents to which such claims are entitled.

What is claimed is:

1. An apparatus for an Integrated Access and Backhaul (IAB) node, the apparatus comprising:
processing circuitry, wherein to configure the IAB node for downlink (DL) power control, the processing circuitry is to:
decode at a distributed unit (DU) function of the IAB node, an uplink (UL) reference signal received via a communication channel from a mobile termination (MT) function of a second IAB node;
determine a path loss associated with the communication channel, based on at least one measurement of the UL reference signal;
determine DL transmission power using the path loss; and
encode data for a transmission to the MT function of the second IAB node using the DL transmission power, the transmission further using a DL bandwidth part (BWP) associated with the channel; and
memory coupled to the processing circuitry and configured to store the determined DL transmission power.

2. The apparatus of claim 1, wherein the processing circuitry is to:
determine the DL transmission power further based on a configured maximum output power of the DU function of the IAB node.

3. The apparatus of claim 2, wherein the processing circuitry is to:
determine the DL transmission power further based on a pre-configured DL target reception power associated with the DL BWP.

4. The apparatus of claim 3, wherein the processing circuitry is to:
determine the DL transmission power further based on an open-loop fractional path-loss compensation factor associated with the DL BWP.

5. The apparatus of claim 4, wherein the processing circuitry is to:
determine the DL transmission power based on a minimum value selected from a group consisting of:
the configured maximum output power of the DU function of the IAB node; and
a sum of pre-configured DL target reception power and the determined path loss modified by the open-loop fractional path-loss compensation factor.

6. The apparatus of claim 1, wherein the processing circuitry is to:
encode second data for a DU DL transmission to the MT function of a second IAB node; and
decode at the DU function of the IAB node, a transmit power control (TPC) command received via the communication channel from the MT function of the second IAB node, in response to the DU DL transmission of the second data.

7. The apparatus of claim 6, wherein the processing circuitry is to:
determine a power adjustment value for the transmission of the data based on the TPC command; and
determine the DL transmission power further based on the power adjustment value.

8. The apparatus of claim 1, wherein the UL reference signal is at least one of:
a sounding reference signal (SRS);
a demodulation reference signal (DMRS);
a physical random access channel (PRACH); and
an IAB-based reference signal.

9. The apparatus of claim 1, wherein the UL reference signal is received via a first beam pair of a plurality of available beam pairs associated with the IAB node and the second IAB node.

10. The apparatus of claim 9, wherein the processing circuitry is to:
encode data for transmission to the MT function of the second IAB node via the first beam pair and using the DL transmission power.

11. The apparatus of claim 1, further comprising transceiver circuitry coupled to the processing circuitry; and, one or more antennas coupled to the transceiver circuitry.

12. A non-transitory computer-readable storage medium that stores instructions for execution by one or more processors of an Integrated Access and Backhaul (IAB) parent node, the instructions to configure the IAB parent node for downlink (DL) power control within an IAB network, and to cause the IAB parent node to:
decode at a distributed unit (DU) function of the IAB node, an uplink (UL) reference signal received via a communication channel from a mobile termination (MT) function of a second IAB node;
determine a path loss associated with the communication channel, based on at least one measurement of the UL reference signal;
determine DL transmission power using the path loss; and
encode data for a transmission to the MT function of the second IAB node using the DL transmission power, the transmission further using a DL bandwidth part (BWP) associated with the channel.

13. The non-transitory computer-readable storage medium of claim 12, wherein executing the instructions further causes the IAB parent node to:
determine the DL transmission power further based on a configured maximum output power of the DU function of the IAB node.

14. The non-transitory computer-readable storage medium of claim 13, wherein executing the instructions further causes the IAB parent node to:
determine the DL transmission power further based on a pre-configured DL target reception power associated with the DL BWP.

15. The non-transitory computer-readable storage medium of claim 14, wherein executing the instructions further causes the IAB parent node to:
determine the DL transmission power further based on an open-loop fractional path-loss compensation factor associated with the DL BWP.

16. The non-transitory computer-readable storage medium of claim 15, wherein executing the instructions further causes the IAB parent node to:
determine the DL transmission power based on a minimum value selected from a group consisting of:
the configured maximum output power of the DU function of the IAB node; and
a sum of pre-configured DL target reception power and the determined path loss modified by the open-loop fractional path-loss compensation factor.

17. The non-transitory computer-readable storage medium of claim 12, wherein executing the instructions further causes the IAB parent node to:
encode second data for a DU DL transmission to the MT function of a second IAB node; and
decode at the DU function of the IAB node, a transmit power control (TPC) command received via the communication channel from the MT function of the second IAB node, in response to the DU DL transmission of the second data.

18. The non-transitory computer-readable storage medium of claim 17, wherein executing the instructions further causes the IAB parent node to:
determine a power adjustment value for the transmission of the data based on the TPC command; and
determine the DL transmission power further based on the power adjustment value.

19. A non-transitory computer-readable storage medium that stores instructions for execution by one or more processors of an Integrated Access and Backhaul (IAB) node, the instructions to configure the IAB node for downlink (DL) power control within an IAB network including an IAB parent node, and to cause the IAB node to:
encode at a mobile termination (MT) function of the IAB node, an uplink (UL) reference signal for transmission to a distributed unit (DU) function of the IAB parent node using a communication channel;
decode data received from the DU function of the IAB parent node;
in response to the received data, encode a transmit power control (TPC) command for transmission to the DU function of the IAB parent node; and
decode second data received from the DU function of the IAB parent node, the second data associated with a transmit power based on the UL reference signal and the TPC command.

20. The non-transitory computer-readable storage medium of claim 19, wherein executing the instructions further causes the IAB node to:
encode the TPC command for transmission to the DU function of the IAB parent node using a physical uplink control channel (PUCCH) or a physical uplink shared channel (PUSCH).
